(19) United States
(12) Patent Application Publication
(10) Pub. No.: US 2007/0232965 A1
(43) Pub. Date: Oct. 4, 2007

(54) Assisted-standing gear for use with dynamic-motion plates

(76) Inventor: Roger J. Talish, Somerville, NJ (US)

Correspondence Address: CARTER, DELUCA, FARRELL & SCHMIDT, LLP, 445 BROAD HOLLOW ROAD, SUITE 225, MELVILLE, NY, 11747, US

(21) Appl. No.: 11/395,803

(22) Filed: Mar. 31, 2006

(51) Int. Cl. A61H 1/02; A63B 26/00

(52) U.S. Cl. 601/5; 482/143; 601/23

(57) ABSTRACT

A medical treatment system is provided for the treatment of weakened bone structures caused by fractures, osteoporosis, or other bone related ailments using a dynamic motion plate. The medical treatment system utilizes a harness and lifting system to assist in supporting the weight of patients who are unable to remain in an upright posture on the dynamic motion plate for the duration of a treatment cycle.

This application claims priority to a PCT application filed on May 5, 2005 and assigned International Application No. PCT/US2005/015628 which claims priority to a United States provisional patent application filed on May 24, 2004 and assigned U.S. Provisional Application Ser. No. 60/573,902; the entire contents of both applications are incorporated herein by reference.

### BACKGROUND

1. Technical Field

The present disclosure, generally, relates to medical system for the treatment of weak bone structures and specifically for the treatment of weak bone structures using a dynamic motion plate in conjunction with assisted-standing gear directed at aiding a patient unable to maintain an upright posture for the duration of a treatment cycle.

2. Description of the Prior Art

Weakened bone structure and improperly healed or slowly healing bone fractures may result in reduced quality of life. Quality of life may be improved for patients with bone fractures by ensuring rapid healing and by inhibiting the loss of bone mineral content (bone mass), and therefore bone strength, associated with fractures. Metabolic bone diseases, such as osteoporosis, also reduce the quality of life.

Osteoporosis is a pernicious disorder usually, but not exclusively, afflicting elderly women. The osteoporotic state can also be manifested by those who are confined to bed and even to astronauts who are subjected to prolonged weightlessness. Osteoporosis occurs through a decrease in bone mass, which makes the afflicted bones more fragile and more susceptible to breakage.

The reduction in bone mass from osteoporosis results when destruction outpaces bone formation. The balance between destruction and formation is affected by hormones, calcium intake, vitamin D and its metabolites, weight, smoking, alcohol consumption, age, genetic determinants and especially exercise or other methods of dynamically loading the bone tissue as well as many other factors. Considering the vast array of factors which can compromise the healing process, any form of stimulation that can accelerate, augment and/or ensure the healing process are greatly needed.

Osteoporosis is not easily determined in its early phases as physical deformity is not yet evident. Because osteoporosis develops progressively, early diagnosis and appropriate treatment may avoid a serious condition. Appropriate diet and exercise can be used in early years to prevent the damaging effects of osteoporosis later in life. Methods for maintaining or promoting bone growth are described in numerous patents. For example, McLeod and Rubin, U.S. Pat. Nos. 5,103,806, 5,191,880, 5,273,028 and 5,376,065 collectively describe means and methods for promoting bone growth and preventing bone loss. The method described in the above referenced patents relates to a mechanical vibrational loading of bones to promote growth in a non-invasive procedure. McLeod and Rubin, U.S. Pat. Nos. 5,103,806, 5,191,880, 5,273,028 and 5,376,065 are all incorporated herein by reference.

Mechanical loading on bone tissue at strains of between about 0.5 to about 500 microstrain and induced within a predetermined frequency range can prevent bone loss and enhance new bone formation. Such mechanical bone loading of tissue may be introduced by various system, including vibrating floor plates and chairs, electrical stimulation of muscles, isometric exercises, modulated ultrasound or transducers attached to the skin or external fixation devices to focus energy to the fracture site.

Elderly patients suffering from fractures or osteoporosis and other patients who may have other physical disabilities and/or impairments may not be able to apply their full weight on to the dynamic motion plate for the full duration of the treatment, especially early on in the treatment process. In these cases, an system is needed to partially support the patient's mass during treatment while providing adequate loading of the bone tissue to reap the optimal benefits of the treatment. Ideally, such an system would provide adjustments allowing a technician or physician to vary the load placed on the bone tissue.

### SUMMARY

The present disclosure provides a medical treatment system for stimulating bone growth in a living vertebrate body (i.e. patient). The system includes a dynamic motion plate, for imparting vibrational motion to the patient. The dynamic motion plate is dimensioned to provide an adequate platform on which the patient is to stand in a natural, essentially upright posture and configured to functionally bear the full mass of the patient, and an assisted-standing gear for providing support to the patient when the patient is unable to bear its full mass on the dynamic motion plate for the duration of the bone growth stimulation.

The assisted-standing gear includes a harness wearable by the patient. The harness has at least one anchor point and straps for securing the harness in a manner that minimizes painful pressure on the patient when mass of the patient is fully supported by the assisted-standing gear. The assisted-standing gear also provides a lifting system for lifting the harnessed patient. The lifting system is attached to the harness by at least one cable attached to at least one anchor point on the harness.

A method for stimulating bone growth in a living vertebrate body is also provided by the present disclosure. The method imparts vibrational motion to the patient using a dynamic motion plate dimensioned to provide an adequate platform for the patient to stand on while maintaining a natural, essentially upright posture and configured to functionally bear the full weight of the patient. Additionally, the patient is supported in the event that the patient is unable to bear his/her full weight on the dynamic motion plate for the duration of the bone growth stimulation procedure. Supporting the patient is performed by harnessing the patient, in a manner so as to minimize painful pressure on the patient when the patient is fully supported, and, subsequently, lifting the harnessed patient by at least one cable attached to at least one anchor point on the harness.

### BRIEF DESCRIPTION OF THE DRAWINGS

These and other features, aspects, and advantages of the present disclosure will become better understood with regard to the following description, appended claims, and accompanying drawings wherein:

FIG. 1 is a schematic view of an embodiment of an assisted-standing gear configured with a dynamic-motion plate in accordance with the present disclosure;

FIG. 2 is an illustration of an embodiment of a harness for use in the assisted-standing gear shown in FIG. 1;

FIG. 3 is a flowchart illustrating the steps of an embodiment of a method treatment using a dynamic motion plate in conjunction with assisted standing gear in accordance with the present disclosure;

FIG. 4 is a schematic view of an additional embodiment of an assisted-standing gear configured as an add-on attachment to a dynamic-motion plate in accordance with the present disclosure; and

FIG. 5 is a schematic view of an additional embodiment of an assisted standing assembly incorporating a lift system in accordance with the present disclosure.

### DESCRIPTION OF THE PREFERRED EMBODIMENTS

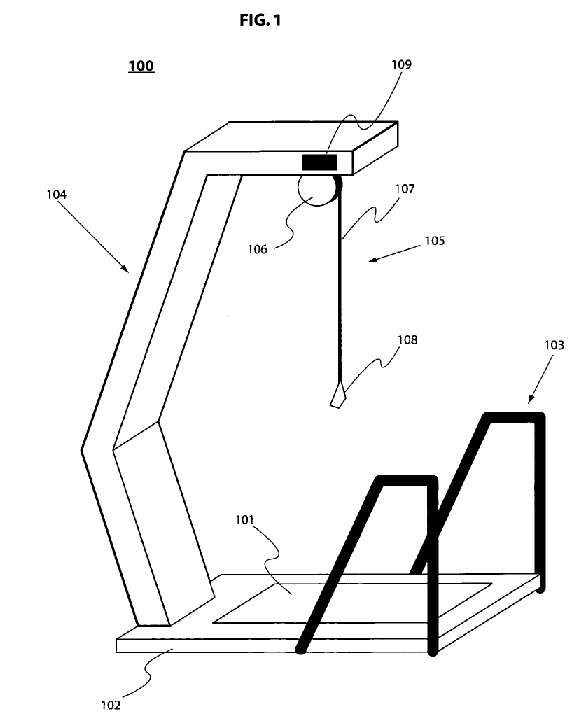

FIG. 1 illustrates a schematic view of a preferred embodiment of a system 100. The system 100 provides a dynamic motion plate 101 incorporated into a base 102. The base 102 is equipped with handrails 103 for providing a patient with lateral stabilizing support while the dynamic motion plate 101 is in operation.

Additionally, a cantilevered pillar 104 is mounted to the base 102. The cantilevered pillar 104 provides a support for a lifting system 105 consisting of a winch 106, cable 107 and a connector 108. The cantilevered pillar 104 and lifting system 105 should provide adequate support, strength and stability to lift patients that may not be able to fully support their weight for the duration of a treatment cycle due to overweight, injury or paralysis. The lifting system 105 may provide a means for varying the percentage of the patient's mass that is being supported by the cantilevered pillar 104. Collectively, the cantilever pillar 104 and the lifting system 105 are referred to herein as “assisted-standing gear”.

Preferably, the winch 106 is an electric stepping motor capable of reeling in specific and controllable lengths of cable 107 thus allowing an operator to accurately control the percentage of mass being supported by the lifting system 105. A weight sensor 109 may be included as a component of the lifting system 105 to provide an indication of the amount of weight being supported by the lifting system 105. The accuracy of the weight sensor 109 should preferably be better than ±1 lb.

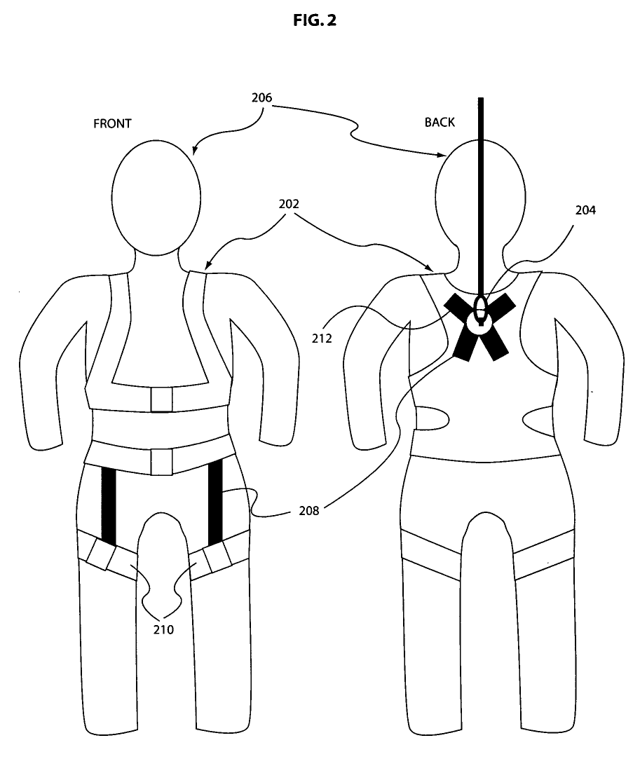

The connector 108, which may be a karabiner or snap-ring type connector, clips onto an anchor ring 204 or other such anchor point on a harness 202 (See FIG. 2) worn by the patient 206. The harness, preferably a variation of commonly available sit or full-body harnesses, provides support for the patient's 206 torso and legs when the lifting system 105 is supporting the patient's 206 weight, thus avoiding discomfort to the patient, while still allowing the patient 206 to reap the benefits of the treatment. The anchor ring 204 is preferably positioned to rest on the mid to upper back of the patient 206 so that when the lifting system 105 is engaged the patient is maintained in an upright or nearly upright posture.

Generally, sit and full-body harnesses as described in U.S. Pat. Nos. 5,145,027, and 6,050,364, herein incorporated by reference, are used as safety harnesses for climbing and therefore provide the anchor ring at the front of the harness. This anchor position, however, would force a patient into an unnatural and uncomfortable posture during the treatment cycle. By moving the anchor ring to the mid or upper back region, the patient can be supported in a manner that would provide better results from the treatment. The preferred harness 202 would thus have leg support straps 208 attached to leg straps 210 and routed inside the harness 202 to the back, where an end of the leg support strap 208 is attached to the anchor ring 204.

Additional upper-body support straps 212 are attached to the upper back portion of the harness 202 at one end and to the anchor ring 204 at the other end. The upper-body support strap 212 is provided with a predefined or adjustable amount of slack in relation to the leg support straps 208. The slack is necessary so that when the patient is supported by the harness, the leg support straps 208 are loaded before the upper-body support straps 212 are, thus forcing the patient's legs to take on a slightly seated position, allowing the patients weight to be supported in a more comfortable manner while still maintaining proper posture with respect to the dynamic motion plate. By adjusting the slack of the upper-body support straps 212, the patient can be placed into more or less of a sitting posture.

Additional embodiments of the present disclosure may include multiple anchor points on the harness 200 with corresponding multiple connectors 108 attached to either a single cable 107 or each connector 108 to a unique cable 107. A controller may also be included for providing control of the lifting system 105, collection and display of data received from any weight sensors, display of elapsed time and/or time remaining in the current treatment cycle, and indicators for alerting an operator of problems that may reduce the effectiveness of the treatment, e.g. the weight being supported by the lifting system 105 has suddenly changed, possibly indicating fatigue of the patient 202, etc. The controller may provide additional applicable diagnostic tools, such as blood pressure and heart rate monitoring—additional hardware components may be necessary.

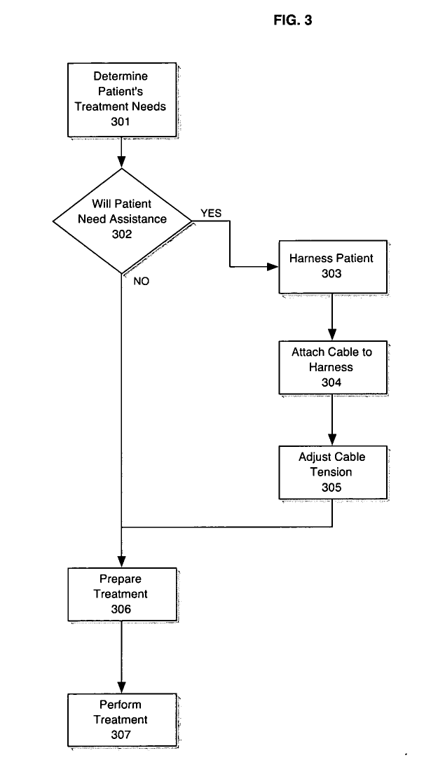

FIG. 3 illustrates an embodiment of the process for performing a bone growth stimulation treatment. Initially, the patient's treatment needs are determined in Step 301. Step 301 includes determining duration of treatment, proper vibrational frequency, etc. Proceeding to Step 302, it is determined if the patient will require assistance standing on the dynamic motion plate 101. A patient may require assistance due to injury, paralysis, excess weight or other medical conditions. Generally, the patient must apply a significant portion of his/her body weight on the dynamic motion plate 101 and maintain a correct upright posture throughout the treatment, which may last for 20 minutes or more.

If the assistance is necessary, the process proceeds to step 303, where the patient is placed in a harness 202. In Step 304, at least one cable 107 is attached to an anchor point 204 on the harness 202. The tension on the cable 107 is adjusted until the proper portion of the patient's weight is supported in Step 305. The process, subsequently, proceeds to Step 306, where the treatment is prepared by adjusting the proper settings for the frequency, duration, etc. as determined in Step 301. Proceeding to Step 307, the treatment is performed. During treatment, it is preferred that the patient is monitored for inappropriate fatigue, stress, improper posture and other related issues which may impact the benefits of the treatment. Appropriate action should be taken to correct these issues.

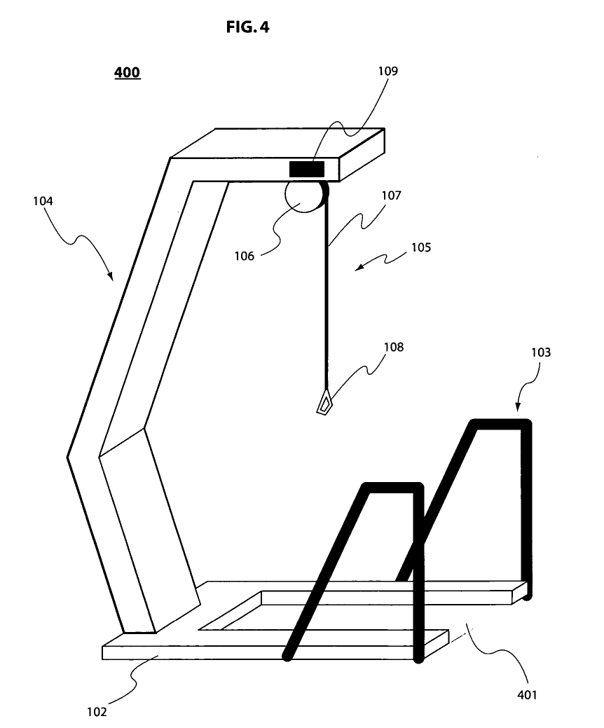

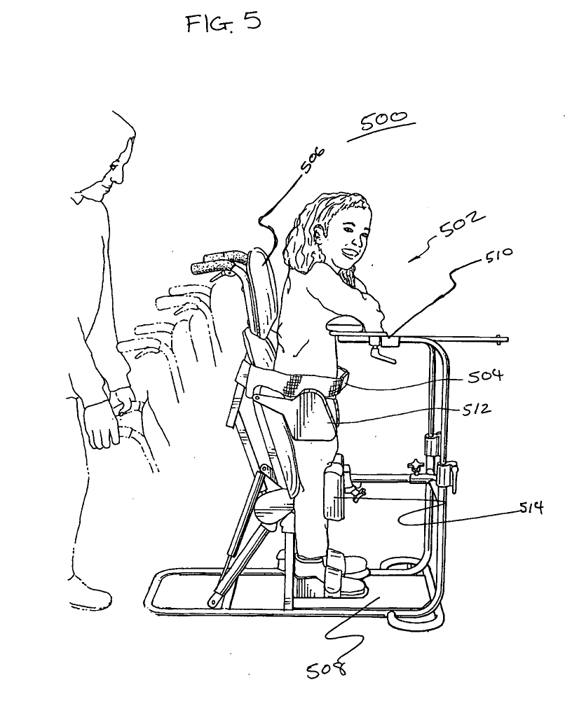

Referring to FIG. 4, an additional embodiment of the present disclosure provides for an assisted-standing gear 400 as an add-on to a pre-existing dynamic motion plate. The assisted-standing gear 400 incorporates all the components of the embodiment shown in FIG. 1, except for the dynamic motion plate 101. In the present embodiment, the assisted-standing gear 400 has a base 102 dimensioned to provide stability and a region 401 for insertion of a dynamic motion plate 101. This region 401 may be configured either as a cutout wherein the dynamic motion plate 101 fits or as a platform, whereupon the dynamic motion plate 101 is placed. Referring to FIG. 5, the system 500 provides standing assistance via a user lift system 502 as disclosed in U.S. Pat. No. 6,440,046, herein incorporated by reference. The lifting system 502 provides a supporting harness 504 and back support 506 and is integrated with a dynamic motion plate 508 positioned at the base. Additional supports and braces may be present, such as upper body supports 510, hip braces 512 and knee braces 514.

The described embodiments of the present disclosure are intended to be illustrative rather than restrictive, and are not intended to represent every embodiment of the present disclosure. Various modifications and variations can be made without departing from the spirit or scope of the disclosure as set forth in the following claims both literally and in equivalents recognized in law.

What is claimed is:

1. A system for stimulating bone growth in a living vertebrate body, said system comprising:
a dynamic motion plate, for imparting vibrational motion in a single plane through the feet of a patient, said dynamic motion plate dimensioned to provide an adequate platform on which said patient is to stand in a natural, essentially upright posture and configured to functionally bear the mass of said patient; and
an assisted-standing gear for providing support to a patient, said gear comprising:
a harness having at least one anchor point and straps for securing said harness on said patient; and
a lifting system for lifting said harnessed patient, said lifting system being attached to said harness by at least one cable attached to said at least one anchor point on said harness.

2. The system of claim 1, wherein said structure is a cantilevered pillar having one cable fixed at a first end to a winch and a second end at said anchor point.

3. The system of claim 2, wherein said cable can be adjusted for varying percent of body mass supported by said assisted-standing gear.

4. The system of claim 1, further comprising:
a weight sensor for detecting the amount mass being supported by said assisted-standing gear;
an interface for receiving operator inputs directed at controlling said lifting system; and
a controller for receiving and displaying information from said weight sensor and for accepting and executing said operator inputs.

5. The system of claim 1, wherein said harness is a sit harness.

6. A method for stimulating bone growth in a living vertebrate body, said method comprising the steps of:
imparting vibrational motion to a patient using a dynamic motion plate dimensioned to provide an adequate platform on which said patient is to stand in a natural, essentially upright posture; and
providing supplemental support to a patient on said dynamic motion plate comprising the steps of:
harnessing said patient; and
lifting said harnessed patient by at least one cable attached to at least one anchor point on said harness.

7. The method of claim 6, wherein said cable is adjusted for varying the proportion of said body mass supported by said assisted-standing gear.

8. The method of claim 6, further comprising the steps of:
detecting the proportion of a patient's weight or mass being supported and displaying the detected weight in an operator readable form; and
receiving operator inputs directed at controlling said lifting system.

9. The method as in claim 6, wherein said harnessing step is performed using a sit harness.

10. An assisted-standing system for providing supplemental support to assist patients to stand in an erect posture during bone growth stimulation treatments using a dynamic motion plate, said system comprising:
a dynamic motion plate for imparting vibrational motion in a single plane through the feet of a patient;
a harness having at least one anchor point and straps for securing said harness on said patient; and
a lifting assembly for lifting said harnessed patient, said lifting system being attached to said harness by at least one cable attached to said at least one anchor point on said harness, said lifting assembly comprising:
a base member configured and dimensioned to accept a dynamic motion plate;
at least one vertical support member attached to said base member at a first end;
at least one cantilevered member affixed to a second end of said at least one vertical support member; and
a winch assembly attached to said at least one cantilever member and attached to an end of said at least one cable.

11. The system of claim 10, wherein said cable can be adjusted for varying percent of body mass supported by said system.

12. The system of claim 10, further comprising:
a weight sensor for detecting the amount mass being supported by said system;
an interface for receiving operator inputs directed at controlling said lifting assembly; and
a controller for receiving and displaying information from said weight sensor and for accepting and executing said operator inputs.

13. The system of claim 10, wherein said harness is a sit harness.

14. A system for stimulating bone growth in a living vertebrate body, said system comprising:
a dynamic motion plate, for imparting vibrational motion in a single plane through the feet of a patient, said dynamic motion plate dimensioned to provide an adequate platform on which said patient is to stand in a natural, essentially upright posture and configured to functionally bear the mass of said patient; and
a user lift system including a back support directed towards supporting said patient's back and a supporting harness positioned around said patient's waist.

15. The system of claim 14, wherein said user lift system further includes at least one of the following: hip brace, knee brace, and upper body support.
